(19) United States
(12) Patent Application Publication
(10) Pub. No.: US 2016/0116137 A1
(43) Pub. Date: Apr. 28, 2016

(54) HIGH-EFFICIENCY LIGHT DISTRIBUTION BOARD FOR LED LAMP HEAD

(71) Applicant: HWASHIN E&B CO., LTD., Cheonan-Chungam (KR)

(72) Inventor: Seung Jin RYU, Cheonan-Chungam (KR)

(21) Appl. No.: 14/923,274

(22) Filed: Oct. 26, 2015

(30) Foreign Application Priority Data
Oct. 27, 2014 (KR) 10-2014-0146315

(51) Int. Cl. F21V 7/04; F21V 7/22

(52) U.S. Cl. CPC F21V 7/041; F21V 7/22; F21Y 2101/02

(57) ABSTRACT

The present invention relates to a light distribution board for an LED lamp head, and particularly, to a high-efficiency light distribution board for an LED lamp head in which the illuminance and the light irradiation range can be freely selected and applied depending on the installation location.

To this end, there is provided a high-efficiency light distribution board for an LED lamp which includes a body portion that is formed in a conical shape whose diameter becomes smaller toward the inside and in which a plurality of LED light source mounting holes capable of mounting a LED light source is formed on one side surface; and a light-emitting member that is inserted into the body portion and is coupled in close contact with the LED light source mounting hole to reflect light emitted from the LED light source mounted on the LED light source mounting hole.

### BACKGROUND

1. Technical Field

The present invention relates to a light distribution board for a LED lamp head, and more particular, to a high efficiency light distribution board that can freely select and apply the illuminance and the light irradiation range, depending on the installation location.

2. Related Art

In general, a lamp using an LED as a light source, by its nature, in order to increase the amount of light, a plurality of LEDs is applied or a high amount of light of power LED is applied.

Due to these characteristics, a plurality of LEDs is mounted on a single substrate or a single light distribution board to adjust the required amount of light irradiation light.

Further, due to this structure, a light reflection structure capable of improving the light efficiency is additionally formed on the light distribution board on which the individual LEDs are mounted, but most of them are formed in the form of a reflecting mirror or a reflector by etching the light distribution board.

However, such prior arts are further subjected to another machining process to increase the light irradiation efficiency, together with shaping of the reflection structure of the light distribution board.

For example, a post-machining is performed by a method such as plating or bonding to form a mirror surface on the inner surface of the reflector.

In this regard, Korean Patent Registration No. 10-0972442 (LED lamp with reflection plate having excellent reflection efficiency attached thereto, hereinafter referred to as “prior art”) discloses a technique which provides a reflection plate on which a plurality of LED light sources can be mounted and machining of a cross-sectional shape is performed to increase the reflection efficiency, but the reflection plate is applied for each LED light source disposed on the same circumference, and the same reflection member is applied.

In such a case, there is a problem of difficulty in setting of the illuminance, and there is a problem of a need for setting the illuminance required for the installation location by adjusting the specifications of the light distribution board.

In addition, there is inconvenience of a need for replacing the entire light distribution board at the time of oxidation of a reflecting sphere or damage caused by external factors, and there is a problem in which the load of the light distribution board increases through the metal fusion and an installation structure to withstand the load is complicated when installed on the LED lamp head.

Thus, there is an urgent need for development of a light distribution board in which coping with the illuminance required in the installation location can be easily performed, the maintenance when damaged can be easily performed, and the light radiation forms can be freely selected and applied.

### SUMMARY

An object of the present invention for overcoming the above-described problems is to provide a high-efficiency light distribution board structure for an LED high lamp head that is capable of freely selecting and applying the member for the light reflection, without post-machining of the reflection structure.

Another object of the invention is to provide a low-load light distribution board to reduce the self-load of the LED lamp head and enhance the installation strength.

According to an aspect of the present invention, there is provided a high-efficiency light distribution board for an LED lamp head, including: a body portion (10) that is formed in a conical shape whose diameter becomes smaller toward the inside and in which a plurality of LED light source mounting holes (11) capable of mounting a LED light source is formed on one side surface; and

a reflection member (20) that is inserted into the body portion (10), and is coupled in close contact with the LED light source mounting hole (11) to reflect light emitted from the light source mounted on the LED light source mounting hole (11).

Further, the reflection member (20) is formed in a conical shape in which an outer diameter portion (21) is formed on one side surface and an inner diameter portion (22) having a circumference smaller than the outer diameter portion (21) is formed on the other side surface, wherein after the side surface portions of the outer diameter portion (21) are pressed so as to be adjacent to each other and the side surface portions of the inner diameter portion (22) are pressed so as to be adjacent to each other such that the reflection member is formed in a triangular shape, the reflection member is disposed so that the inner diameter portion (22) comes into contact with the LED light source mounted on the LED light source mounting hole (11), and the outer diameter portion (21) is disposed to be adjacent to an inlet of the LED light source mounting hole (11) of the body portion (10), and a coupling protrusion (12) for preventing the reflection member (20) inserted therein from being disengaged from the LED light source mounting hole (11) is further formed on the circumference adjacent to the inlet of the LED light source mounting hole (11) of the body portion (10).

At least one of a highly-reflective silver deposition film in which a PET resin layer is disposed on a bottom portion, a metal layer is formed on a top of the PET resin layer, a silver coating layer is formed on a top surface of the metal layer and a transparent PET resin layer is applied to the top surface of the silver coating layer, or a diffused reflection film made up of an optical PET film is applied as the reflection member (20). After both end surfaces of the reflection member (20) are adjacent to each other so that the reflection member is formed in a triangular shape, the reflection member is inserted into the LED light source mounting hole (11) of the body portion (10), and when removing the binding pressure, the reflection member (20) is bound by coming into close contact with the inner circumferential surface of the LED light source mounting hole (11) by its restoring force. Thus, by providing a high-efficiency light distribution board for the LED lamp head which is easy to perform the manufacturing and maintenance and can be variously applied depending on the state of the field, it is possible to achieve better the object of the present invention.

By providing the high-efficiency light distribution board structure of the LED lamp head of the present invention, there is an effect capable of providing a high-efficiency light distribution board that is easy to perform the manufacturing and maintenance, and can easily set the illuminance and the light irradiation range, depending on the situation of the field.

### BRIEF DESCRIPTION OF DRAWINGS

FIG. 1 is a perspective view of the present invention;

FIG. 2 is a plan view of the present invention;

FIG. 3 is a perspective view of a reflection member;

FIG. 4 is a partially cutaway view for illustrating a cross-sectional structure of an example of the reflection member;

FIG. 5 is a partially cross-sectional view for illustrating a coupling structure of the present invention;

FIG. 6 is a cross-sectional view for illustrating an application state of the present invention; and

FIGS. 7 and 8 are exemplary diagrams for illustrating an embodiment of the present invention.

### DETAILED DESCRIPTION

Hereinafter, a high-efficiency light distribution board structure of an LED lamp head, more specifically LED street lamp head, of the present invention will be described in detail with reference to the accompanying drawings so that those skilled in the art can easily embody.

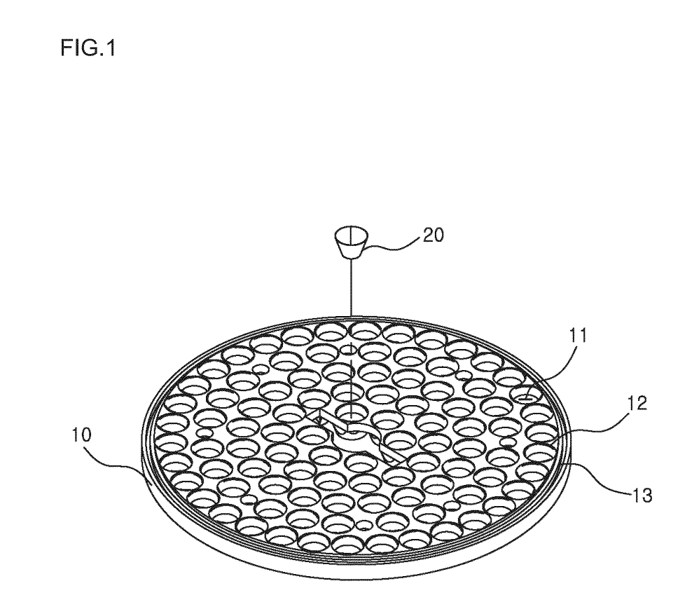

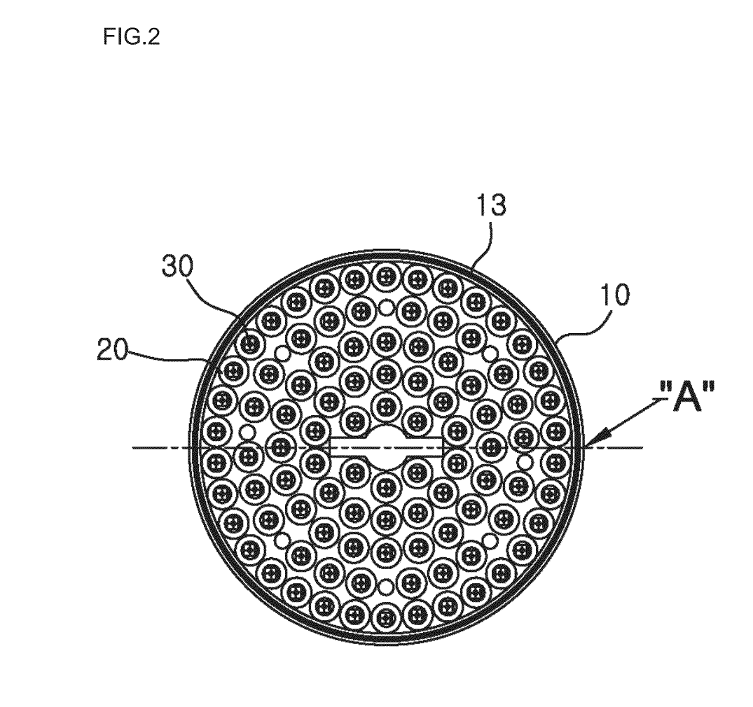

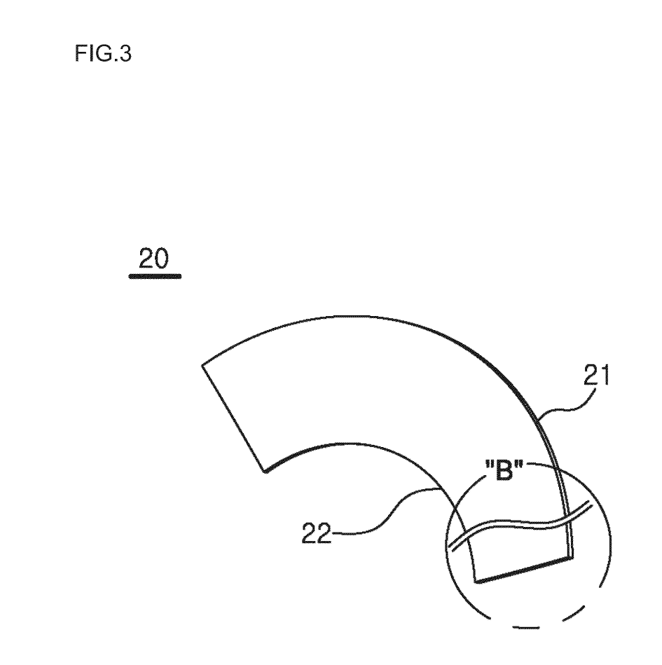

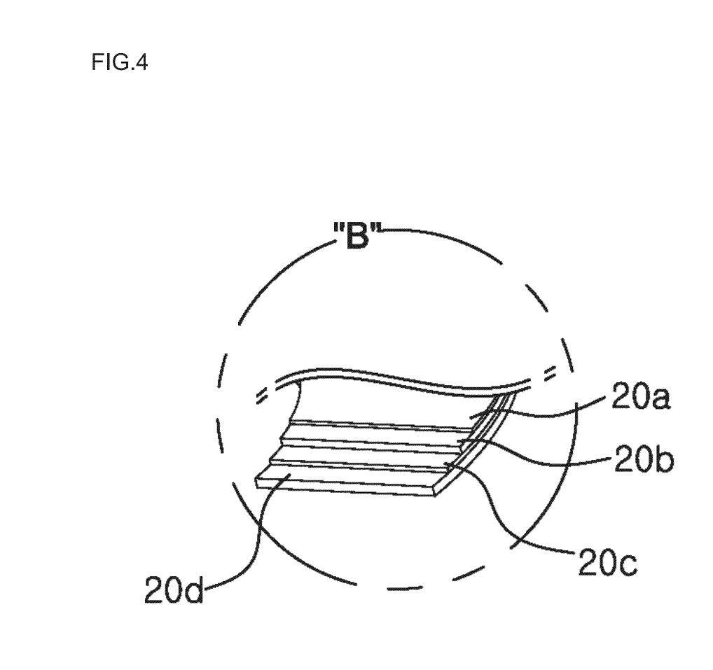

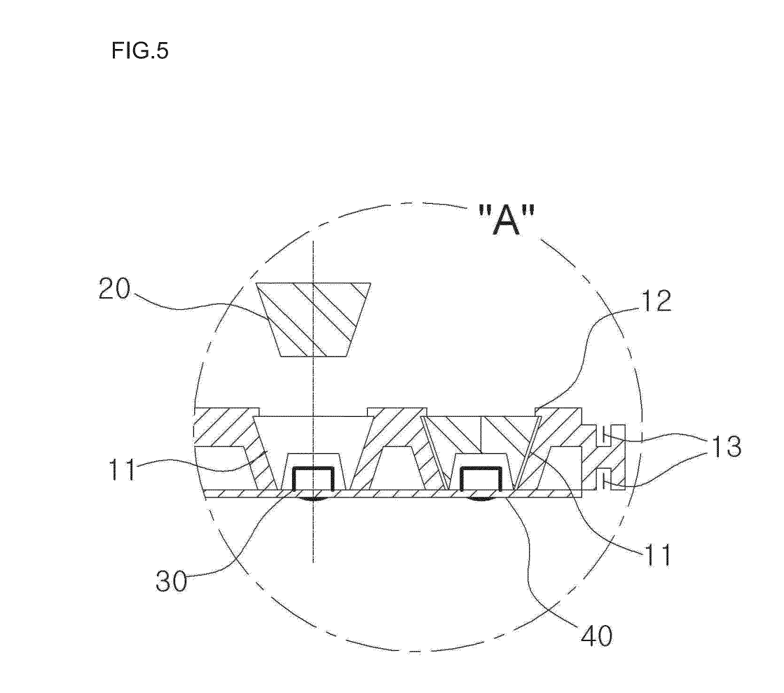

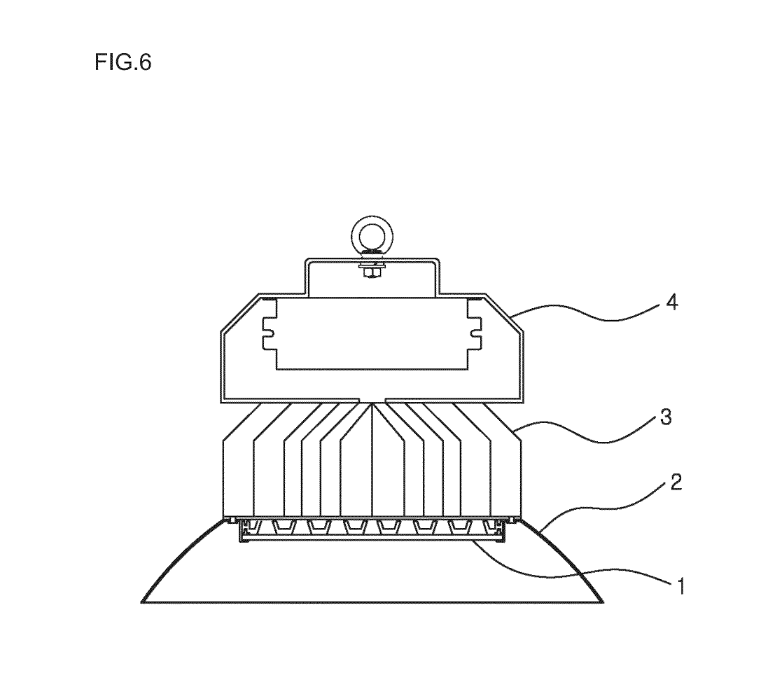

FIG. 1 is a perspective view of the present invention, FIG. 2 is a plan view of the present invention, FIG. 3 is a perspective view of the reflection member (20), FIG. 4 is partially cutaway view for illustrating a cross-section configuration of an example of the reflection member (20), FIG. 5 is a partially cross-sectional view for illustrating a coupling structure of the present invention, and FIG. 6 is a cross-sectional view for illustrating an application state of the present invention.

The description will be given in detail with reference to FIGS. 1 to 6. A high-efficiency light distribution board (1) for a LED street lamp head according to the present invention is applied to a head of a street lamp which uses an LED as a primary light source. In more detail, the light distribution board is coupled to one side of a street lamp head in which a plurality of LED is equipped, and makes it possible to more efficiently irradiate light emitted from each LED. The light distribution board is used by being coupled to one side of a casing (4) equipped with a stabilizer or the like, a heat radiating member (3) coupled to the bottom portion of the casing (4), and a circuit substrate (2) having a plurality of LED light sources.

To this end, the light distribution board (1) is configured to include a body portion (10) having LED light source mounting holes (11) capable of mounting a plurality of LED light sources thereon, and a reflection member (20) that is inserted into the LED light source mounting holes (11) of the body portion (10) and comes into contact with the inner diameter.

At this time, a plurality of coupling protrusions (12) is further formed on the circumference adjacent to the inlet of the LED light source mounting hole (11) of the body portion (10), and the coupling protrusions (12) are intended to prevent the reflection member (20) inserted therein from being disengaged from the LED light source mounting hole (11).

Here, although the body portion (10) has been described on the basis of a circular shape for the practice of the present invention, it is not limited thereto, and it can be variously applied, depending on the shape of the street lamp head having a plurality of LEDs.

In addition, the outer peripheral end surface of the body portion (10) allows a packing for cushioning and sealing to be inserted, when a pair of packing holes (13) is formed on a front portion and a rear portion and is coupled to the street lamp head.

The LED light source mounting hole (11) of the body portion (10) formed as described above is formed in a conical shape whose diameter becomes smaller toward the inner side, and is formed so that the LED light source can be mounted on the inside.

The reflection member (20) inserted into the LED light source mounting hole (11) of the body portion (10) includes a highly-reflective silver deposition film on which silver is deposited on one surface, or a diffused reflection film for diffuse reflection.

At this time, the highly-reflective silver deposition film is obtained by depositing silver (Ag) on one side surface of the PET film to serve as a mirror (see FIG. 4).

In more detail, a PET resin layer (20d) is mounted at the bottom portion, a metal layer (20c) is mounted on the top of the PET resin layer (20d), a silver coating layer (20b) is coated on the top surface of the metal layer (20c), and a transparent PET resin layer (20a) is applied on the top of the silver coating layer (20b) to form a silver deposition film.

In this way, the application of the PET resin layer to each of the bottom portion and the top portion is to prevent an electric shock from being applied to the LED light source (30) adjacent to the reflection member (20), and to prevent the silver coating layer (20b) from being oxidized due to ultraviolet rays emitted from the LED light source (30).

Further, a liquid metal such as copper (Cu) is applied to the metal layer (20c) to facilitate application of silver (Ag), or the deposition or the metal sheet of thin film is applied.

Also, the optical PET reflective film is applied as the diffused reflection film used in combination with the highly-reflective silver deposition film, and typically, a Teijin DuPont films is used, but it is not limited thereto.

In this manner, the use of the silver deposition film and the diffused reflection film in combination as the reflection member (20) is to set the illuminance and the light irradiation range needed to be differently applied, depending on the installation location.

For example, the silver deposition film has the function of irradiating the light by concentrating the light for the highly-reflective use, and the diffused reflection film is applied for the indirect illumination.

By applying these two types of reflection members, it is possible to set the illuminance and the light irradiation range required at the installation location.

This is to overcome the problem of difficulty of application in the field, since the reflection member is produced while the illuminance and the light irradiation range being fixed at the time of production in the case of the conventional street lamp head.

The reason is that a reflection member needs to be uniformly applied to the conventional street lamp head, since the reflection material is deposited or plated on the entire reflection surface, after the reflection plate on which the reflecting mirror or individual LED light source can be mounted is made of metal or synthetic resin.

The above-described reflection member (20) is formed in a fan shape, and can be formed in a triangular shape when applying the pressure so that both side end portions are adjacent to each other.

At this time, an outer diameter portion (21) is formed on one side surface of the reflection member (20), and an inner diameter portion (22) having the circumference smaller formed than the outer diameter portion (21) is formed on the other side surface thereof. After the reflection member is formed into a triangular shape by pressing side surface portions of the outer diameter portion (21) so as to be adjacent to each other and side surface portions of the inner diameter portion (22) so as to be adjacent to each other, the inner diameter portion (22) comes into contact with the LED light source mounted on the LED light source mounting hole (11), and the outer diameter portion (21) is disposed to be adjacent to the inlet of the LED light source mounting hole (11) of the body portion (10).

In more detail, after the reflection member (20) is formed into a triangular shape by making both end surfaces of the reflection member (20) in contact with each other, the reflection member (20) is inserted into the LED light source mounting hole (11) of the body portion (10) to the inner diameter portion (22) side, and when removing the pressure which binds the reflection member (20), the reflection member (20) comes into close contact with the inner peripheral surface of the LED light source mounting hole (11) by its restoring force.

After the reflection member (20) is come into close contact with the LED light source mounting hole (11) as described above, the outer diameter portion (21) is supported by the coupling protrusion (12) to prevent the reflection member (20) from being disengaged from the main body form (10).

This is intended to enable the easier production without a separate adhesive member and the easier setting of the illumination and the light irradiation range in the field, by inserting and binding the reflection member (20) into the LED light source mounting hole (11) of the body portion (10), after an operator makes both end surfaces of the reflection member (20) in contact with each other during production.

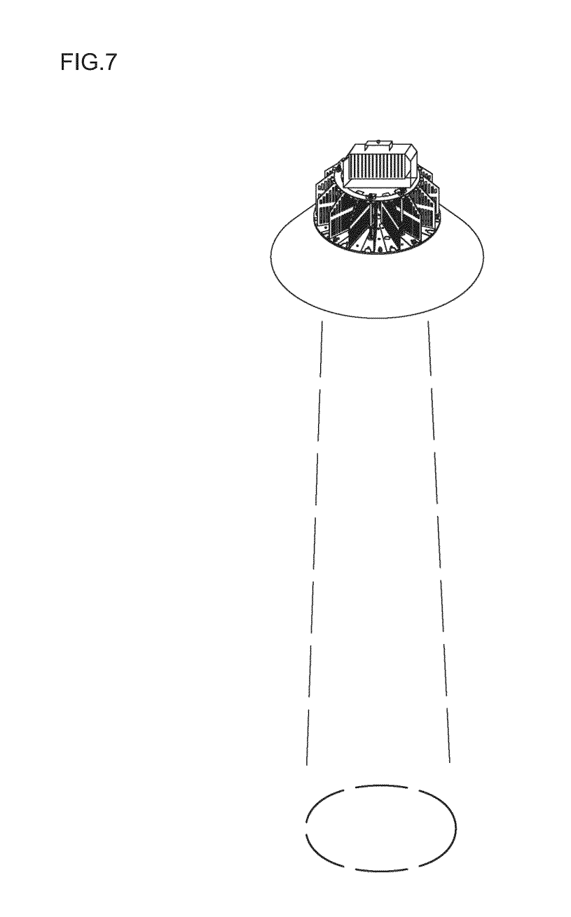

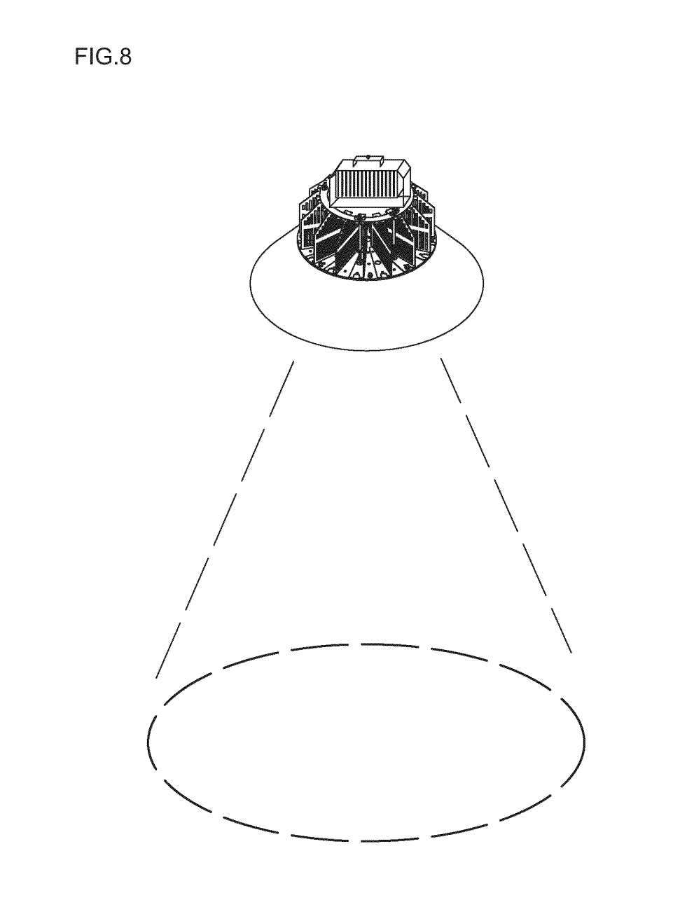

FIGS. 7 and 8 are illustrative diagrams for illustrating an embodiment of the present invention.

With reference to FIGS. 7 and 8, when applying the highly-reflective silver deposition film, the invention can be applied to the concentration illumination in which the light irradiation range is narrow as shown in FIG. 7, and when applying the diffused reflection film, the invention can be applied to the indirect illumination in which the light irradiation range is formed to be wide as shown in FIG. 8.

Also, by applying the silver deposition film and the diffused film in combination depending on the field conditions, it is possible to set the light irradiation range and illuminance suitable for the field.

With such a configuration, the present invention can be completed.

What is claimed is:

1. A high-efficiency light distribution board for an LED lamp head applied to an LED lamp head, the light distribution board comprising:
a body portion that is formed in a conical shape whose diameter becomes smaller toward the inside and in which a plurality of LED light source mounting holes capable of mounting a LED light source is formed on one side surface; and
a reflection member that is inserted into the body portion, is coupled in close contact with the LED light source mounting hole, and is formed in a conical shape in which an outer diameter portion is formed on one side surface and an inner diameter portion having a circumference smaller than the outer diameter portion is formed on the other side surface to reflect light emitted from the light source mounted on the LED light source mounting holes,
wherein after the side surface portions of the outer diameter portion are pressed so as to be adjacent to each other and side surface portions of the inner diameter portion of the reflection member are pressed so as to be adjacent to each other such that the reflection member is formed in a triangular shape, the reflection member is inserted into the LED light source mounting hole so that the inner diameter portion comes into contact with the LED light source mounted on the LED light source mounting hole, and the outer diameter portion is disposed to be adjacent to an inlet of the LED light source mounting hole of the body portion, and thereafter, when removing the binding pressure, the reflection member comes into close contact with the inner circumferential surface of the LED light source mounting hole by its restoring force.

2. The high-efficiency light distribution board for the LED lamp head according to claim 1, wherein a coupling protrusion for preventing the reflection member inserted therein from being disengaged from the LED light source mounting hole is further formed on the circumference adjacent to the inlet of the LED light source mounting hole of the body portion.

3. The high-efficiency light distribution board for the LED lamp head according to claim 1, wherein at least one of a highly-reflective silver deposition film in which a PET resin layer is disposed on a bottom portion, a metal layer is formed on a top of the PET resin layer, a silver coating layer is formed on a top surface of the metal layer and a transparent PET resin layer is applied to the top surface of the silver coating layer, and a diffused reflection film made up of an optical PET film is applied as the reflection member.
